(19) United States
(12) Patent Application Publication
(10) Pub. No.: US 2006/0129454 A1
(43) Pub. Date: Jun. 15, 2006

(54) Methods and systems for implementing a group buy

(76) Inventors: Susan R. Moon, Manhasset, NY (US); Eric H. Yellin, Cambridge, MA (US); Alice C. Yu, Brooklyn, NY (US); Kevin K. Hung, Forest Hills, NY (US); Evan G. Minskoff, New York, NY (US); B. George Ballman JR., Potomac, MD (US)

Correspondence Address: KILPATRICK STOCKTON LLP, 607 14TH STREET, N.W., WASHINGTON, DC, 20005, US

(21) Appl. No.: 11/205,825

(22) Filed: Aug. 17, 2005

Related U.S. Application Data
(60) Provisional application No. 60/602,295, filed on Aug. 17, 2004.

(51) Int. Cl. G06Q 30/00

(52) U.S. Cl. 705/14; 705/26

(57) ABSTRACT

Methods and systems for utilizing consumer transaction data to target and aggregate consumers for a group purchase involve maintaining a database storing transaction data consisting at least in part of data related to product purchase transactions for a plurality of consumers and analyzing the data related to product purchase transactions to identify members of a group of said plurality of consumers with a purchase history indicative of a preference for purchasing products in at least one pre-defined category of products. Based on such “data mining”, each member of the identified group of consumers is provided an offer to participate in a group purchase in which each member of the group who accepts the offer agrees to purchase a pre-designated product within the at least one category of products, and a purchase of a quantity of the pre-designated product from a vendor is negotiated at a discounted price based at least on part on an aggregation of purchasing power of the members of the group who accept the offer to participate in the group purchase.

### PRIORITY APPLICATION

This application claims priority to co-pending U.S. Provisional Application No. 60/602,295, filed Aug. 17, 2004, entitled “METHODS AND SYSTEMS FOR IMPLEMENTING A GROUP BUY”, which is incorporated herein by this reference.

### FIELD OF THE INVENTION

The present invention relates generally to the field of data mining, and more particularly to methods and systems for utilizing consumer transaction data (e.g., Level 1 data, SKU-level data, customer profile data, etc.) to aggregate consumers for a “group buy” from a vendor.

### BACKGROUND OF THE INVENTION

Currently, customers typically shop by going to a retailer which purchases its inventory from another entity (which in turn may possibly purchase its inventory from still another entity and so on). Accordingly, there is a value chain along which products may be marked up at each step. In other words, from the time a product is created or manufactured, each entity in the value chain essentially extracts profits. A global financial institution, such as a bank, has a customer base that includes millions of consumers whose transactions flow through the financial institution. As a result, the financial institution has an enormous amount of data on what products those consumers are purchasing, when they are purchasing those products, from whom, where they are purchasing those products, and how they pay for those products. There is a present opportunity to utilize that data to match consumers with what they are purchasing, to eliminate some of the intermediate entities' markups in the value chain.

### SUMMARY OF THE INVENTION

It is a feature and advantage of the present invention to provide methods and systems for utilizing consumer transaction data across data levels to target and aggregate consumers for a “group buy” from a vendor that enables a financial institution to negotiate an advantageous price with a manufacturer and resell the item to the consumers, thus eliminating various “middlemen” in the value chain.

It is another feature and advantage of the present invention to provide methods and systems for utilizing consumer transaction data to target and aggregate consumers for a “group buy” from a vendor that has an interactive capability that allows consumers to see the impact of consolidating their (i.e., the groups') purchasing power with the retailer and/or the manufacturer to receive discounts or perhaps better products.

It is an additional feature and advantage of the present invention to provide methods and systems for utilizing consumer transaction data to target and aggregate consumers for a “group buy” from a vendor in which the maximum amount a consumer is willing to spend can be locked in, and as the number of buyers who sign up increases to a pre-determined quantity, the consumer can see the price decrease in inverse relation to the volume of buyers that sign up.

It is a further feature and advantage of the present invention to provide methods and systems for utilizing consumer transaction data to target and aggregate consumers for a “group buy” from a vendor that enables a retailer to conclude a large one-time guaranteed sale or unload overstock or reduce inventory in general.

It is a further feature and advantage of the present invention to provide methods and systems for utilizing consumer transaction data across data levels, and to target and aggregate consumers for a “group buy” from a vendor that will enable a consumer to receive a refund for the amount they prepaid less the final established price set by, and dependent upon, the volume of the group, and where such refund will be by the original selected method of payment, or that may be in another form, such as a credit for future purchases, free complementary products, or free shipping, or the like.

To achieve the stated and other features, advantages and objects, embodiments of the present invention provide methods and systems for utilizing consumer transaction data to target aggregated consumers for a “group buy” in which a financial institution, such as a bank, mines its database to identify products that consumers are buying and when, where, from whom they are buying those products, and how they are paying and funding those products. The financial institution targets those consumers who are customers of the financial institution and gives them an opportunity to opt in to/participate in a program whereby they essentially agree to purchase a particular product. The financial institution then aggregates the buying power of the relatively large number of those consumers who opt in to purchase the particular product and approach a vendor (preferably a manufacturer) with an offer to purchase a large number of the particular item for the aggregated number of consumers. The financial institution negotiates an advantageous price with the manufacturer and resells the item to the consumers who opted in, thus eliminating various “middlemen” in the value chain.

In an embodiment of the invention, a database is maintained that stores transaction data consisting at least in part of data related to product purchase transactions for a plurality of consumers, and the data related to product purchase transactions is analyzed to identify members of a group of such consumers with a purchase history indicative of a preference for purchasing products in one or more pre-defined categories of products. Based upon such “data mining”, each member of the identified group of consumers is provided an offer to participate in a group purchase in which each member of the group who accepts the offer agrees to purchase a pre-designated product, and a purchase of a quantity of the pre-designated product is negotiated with a vendor at a discounted price based at least in part on the aggregation of purchasing power of the members of the group who accept the offer to participate in the group purchase.

The database for an embodiment of the invention stores data consisting at least in part of data related to product purchase transactions for a plurality of customers of a financial institution, such as a bank, and is analyzed by the bank. In an embodiment of the invention, the product purchase transaction data consists at least in part of identification of product purchased, date of product purchased, location of product purchased, identification of vendor from whom product was purchased, and method of payment for the product purchased for each of the plurality of consumers. In further embodiments, the product purchase transaction data that can include, for example, one or more of Level 1 data, SKU-level data, or customer profile data.

In embodiments of the invention the offer to participate in the group purchase is made to customers of the financial institution, such as the bank. In other embodiments, each member of the group who accepts the offer agrees to purchase the pre-designated product for a locked-in pre-determined maximum purchase price. In further embodiments, the locked-in pre-determined maximum purchase price decreases in a pre-defined relationship to an increase in a number of members of the identified group of consumers who accept the offer. In still other embodiments, the locked-in pre-determined maximum purchase price decreases in increments, i.e. in steps, in a pre-defined relationship to incremental, i.e. stepwise, increases in the number of members of the identified group of consumers who accept the offer within a plurality of pre-defined periods of time.

Additional embodiments of the invention provide an interactive capability enabling consumers to access information about the number of members who have accepted the offer and the decrease in the locked-in pre-determined maximum purchase price according to the pre-defined relationship, or an alert, such as an online or telephonic alert, can be provided to consumers with information about the number of members who have accepted the offer and the decrease in the locked-in pre-determined maximum purchase price according to the pre-defined relationship.

In embodiments of the invention, the financial institution negotiates, for example, directly with a manufacturer of the pre-designated product or with a retailer which has an overstock of the pre-designated product and acts as a broker between the manufacturer or retailer and the members of the group who accept the offer.

In other embodiments of the invention, payment is received from each member of the group who accepts the offer to participate in the group purchase via a transactional account. In further embodiments, a discount from a locked-in pre-determined maximum purchase price can be credited back to the member based on the number of members of the identified group of consumers who accept the offer.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a table that illustrates examples of types of consumer product purchase transaction data that is stored and analyzed for embodiments of the invention; and

FIG. 2 is a flow chart that illustrates an example of the process of utilizing consumer transaction data to target and aggregate consumers for a “group buy” from a vendor for an embodiment of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

An aspect of the present invention involves a concept referred to herein as “group buy,” in which a financial institution, such as a bank, leverages its database to identify what products consumers are buying, when, in what categories they are buying those products, and how they are paying for those products. Thus, consumers who are customers of the financial institution can be targeted by the financial institution and given an opportunity to commit to purchase a particular product.

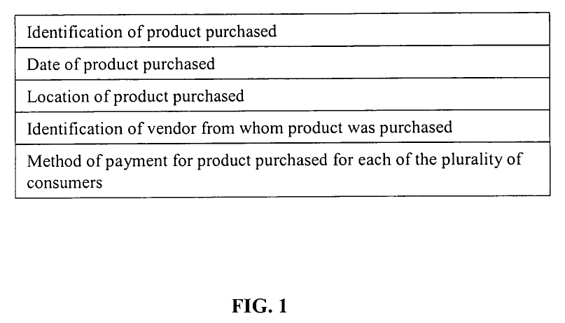

A data mining aspect of the invention targets, for example, past transaction history for the types of products consumers prefer to buy, such as electronics versus home products and the like. FIG. 1 is a table that illustrates examples of types of consumer product purchase transaction data that is stored and analyzed for embodiments of the invention. In the data mining aspect, the financial institution mines its database to identify products that consumers are buying and when, where, from whom they are buying those products, and how they are paying and funding those products. Also, the financial institution can identify and target consumers who, for example, are moving, building a house, or the like.

In an embodiment of the invention, the financial institution then aggregates the buying power of the relatively large number of those consumers who opted in/committed to purchase the particular product, and approach a vendor (preferably a manufacturer) with an offer to purchase a large number of the particular item for the aggregated number of consumers. The financial institution negotiates an advantageous price with the manufacturer and resells the item to the consumers, thus eliminating various “middlemen” in the value chain.

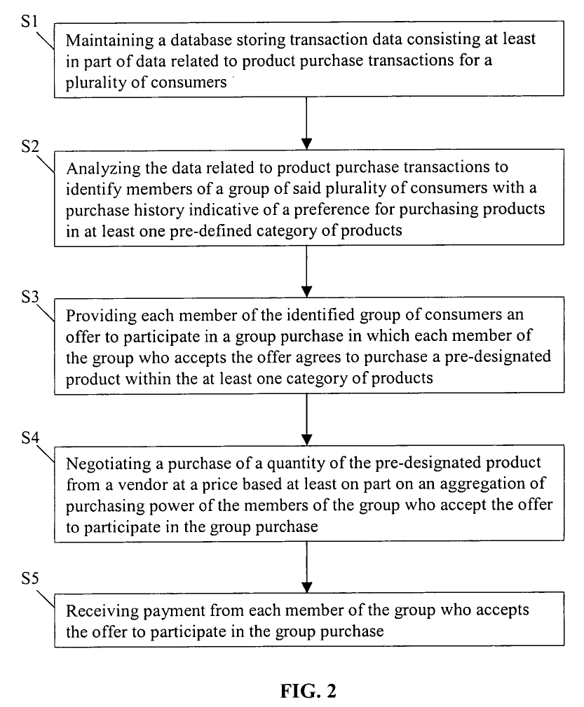

FIG. 2 is a flow chart that illustrates an example of the process of utilizing consumer transaction data to target and aggregate consumers for a “group buy” from a vendor for an embodiment of the invention. Referring to FIG. 2, at S1, a database maintained by a financial institution, such as a bank, stores transaction data consisting at least in part of data related to product purchase transactions for a plurality of consumers. At S2, the data related to product purchase transactions is analyzed by the financial institution to identify members of a group of said plurality of consumers with a purchase history indicative of a preference for purchasing products in at least one pre-defined category of products. At S3, the financial institution provides members of the identified group of consumers an offer to participate in a group purchase in which each member of the group who accepts the offer agrees to purchase a pre-designated product within the at least one category of products. At S4, the financial institution negotiates a purchase of a quantity of the pre-designated product from a vendor at a discounted price based on an aggregation of purchasing power of the members of the group who accept the offer to participate in the group purchase. At S5, payment is received by the financial institution from each member of the group who accepts the offer to participate in the group purchase.

The financial institution can work, for example, with a major retailer that has relationships with manufacturers. In cooperation with the retailer, the financial institution can offer its and the retailer's customer bases an option to sign up to pre-buy, for example, a new “Lord of the Rings” DVD before its release, and as the number of customers who sign up to pre-buy the DVD increases, the price continues to drop. Customers can, for example, go online, or go into one of the retailer's stores and see how many customers have already signed up and observe the price dropping as the number increases.

An embodiment of the invention provides an interactive capability that allows consumers to see the impact of consolidating their purchasing power with the retailer and/or the manufacturer to receive discounts or perhaps better products. Accordingly, there is also a viral communication/marketing nature of this invention, whereby an interactive community and/or buying network is created through word of mouth, as each participant in turn relates to new participants the benefits of the invention, so that the new participants also commit to the purchase to cause the price to drop further (after which the newly informed parties also participate in word of mouth communication and extend the buying network further to others, such as friends, family, etc., who join the network to cause still lower prices).

The nature of products for embodiments of the invention ranges from relatively small items, such as DVDs, to much larger items, such as plasma screen TVs. For example, the financial institution may likewise say that if ten thousand customers sign up to pre-buy a particular plasma screen TV within a certain period of time, such as a month, they will be able to buy it at a particular discounted price, or if fifty thousand customers sign up to pre-buy it within that period of time, they will be able to buy it at an even more deeply discounted price, receive a discounted interest rate and/or a favorable payment plan (installment loan). Thus, customers who have signed up (and/or alternatively, customers may not have committed to sign up) can observe the approach of one or the other of those numbers and may be motivated to sign up to capture one or the other of the discounted prices.

In embodiments of the invention, the financial institution typically does not stock any inventory of any of the products that are offered, but essentially plays the role of broker in matching the seller or manufacturer of a product with buyers.

In an embodiment of the invention, consumers can sign up via a number of both proactive and reactive channels. For example, consumers are able to proactively sign up on a website or perhaps call a 1-800 number. The financial institution may also target consumers by saying to them, for example, “We have noticed that you seem very interested in consumer electronics, and we have a great new program . . . If you are interested in any of the following items, let us know” and consumers can respond by signing up.

In embodiments of the invention, consumers can pay for the purchase, for example, with an existing credit card, debit card, or other transactional account, and the financial institution or the vendor can credit back the discount to a range of consumer accounts. The financial institution can also hold the cash or charge or put it onto its own account. Alternatively, if the financial institution works with a specific retailer or partner which has, for example, a private label account or a stored value/store type of account, the purchase price can be posted to that account and a rebate issued, or the charge can be held, for example, and processed at the time of the closing of the enrollment period.

In another aspect, somewhat similar to a bidding process, consumers can give the financial institution a price ceiling or maximum amount they are willing to pay for the particular product. Thus, the maximum amount a consumer is willing to spend can be locked in, but as the number of buyers who sign up increases, for example, to a pre-determined quantity, the price decreases in inverse relation to the volume of buyers that sign up. Likewise, alerts or alternative means of communication can be utilized to assist the consumer in determining when and if to participate in the “group buy.” Consumers can also customize their alerts in order to be informed about only those group buy events, processes, products, categories, and other related variables attached to the group buy in which they are interested.

Embodiments of the invention also include a time within which to reach the target number of buyers to achieve a certain discount that depends, for example, on what the financial institution negotiates with the vendor, such as a manufacturer or a retailer. Accordingly, the time limit is of variable duration depending on the particular item or service that is being sold.

In an embodiment of the invention, the financial institution works directly with a manufacturer and acts as sponsor and front-end with consumers. In another embodiment of the invention, the financial institution can partner with a major retailer. An advantage of the latter aspect is that such a retailer already has all of the relationships in place with manufacturers, which eliminates the necessity of the financial institution forging those relationships itself. Advantages to such a retailer partnership include, for example, concluding a large one-time guaranteed sale, or perhaps helping the retailer to unload overstock or reduce inventory in general.

In the event the financial institution works with one or more partners to implement the “group buy”, the financial institution can provide the “group buy” functionality to such partners. However, the financial institution is responsible for the receivables arising out of the “group buy” and owns any receivables with new customers who sign up for the “group buy”. Partners can join the financial institution to facilitate such functionality for their own customers and facilitate the financial institution's introduction, for example, to their own merchant partners, thereby increasing the population to which the “group buy” vehicle can be marketed. For example, the financial institution can partner with an enterprise that has a presence both online and on television, such as a large scale merchant, that allows customers who see an advertisement on television to order by phone or on-line. The financial institution can become a pipeline to the partner's customers, for example, for messaging and can potentially become responsible for and the owner of messaging delivered for the partner in tandem with the financial institution to its customers.

Embodiments of the invention and various aspects of the invention can be implemented wholly or partly utilizing computer hardware and software including, without limitation, machine-readable medium on which is encoded program code for implementing and managing the “group buy” for embodiments of the invention.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for utilizing consumer transaction data to target and aggregate consumers for a group purchase, comprising:
maintaining a database storing transaction data consisting at least in part of data related to product purchase transactions for a plurality of consumers;
analyzing the data related to product purchase transactions to identify members of a group of said plurality of consumers with a purchase history indicative of a preference for purchasing products in at least one pre-defined category of products;
providing each member of the identified group of consumers an offer to participate in a group purchase in which each member of the group who accepts the offer agrees to purchase a pre-designated product within the at least one category of products;
negotiating a purchase of a quantity of the pre-designated product from a vendor at a price based at least in part on an aggregation of purchasing power of the members of the group who accept the offer to participate in the group purchase; and
receiving payment from each member of the group who accepts the offer to participate in the group purchase.

2. The method of claim 1, wherein maintaining the database further comprises maintaining the database consisting at least in part of data related to product purchase transactions for a plurality of financial institution customers by a financial institution.

3. The method of claim 2, wherein maintaining the database by the financial institution further comprises maintaining the database consisting at least in part of data related to product purchase transactions for a plurality of bank customers by a bank.

4. The method of claim 1, wherein analyzing the data further comprises analyzing the data by a financial institution.

5. The method of claim 4, wherein analyzing the data by a financial institution further comprises analyzing the data by a bank.

6. The method of claim 1, wherein analyzing the data further comprises analyzing the data related to product purchase transactions consisting at least in part of identification of product purchased, date of product purchased, location of product purchased, identification of a vendor from whom product was purchased, and method of payment for product purchased for each of the plurality of consumers.

7. The method of claim 1, wherein analyzing the data further comprises analyzing at least one of Level 1 data, SKU-level data, and customer profile data.

8. The method of claim 1, wherein providing the offer further comprises providing each member of the identified group of consumers who are customers of a financial institution the offer to participate in the group purchase by the financial institution.

9. The method of claim 8, wherein providing the offer to consumers who are customers of the financial institution further comprises providing each member of the identified group of consumers who are customers of a bank the offer to participate in the group purchase by the bank.

10. The method of claim 1, wherein providing the offer further comprises providing each member of the identified group of consumers the offer to participate in the group purchase in which each member of the group who accepts the offer agrees to purchase the pre-designated product for a locked-in pre-determined maximum purchase price.

11. The method of claim 10, wherein providing the offer further comprises providing each member of the identified group of consumers the offer to participate in the group purchase in which each member of the group who accepts the offer agrees to purchase the pre-designated product for the locked-in pre-determined maximum purchase price, which decreases in a pre-defined relationship to an increase in a number of members of the identified group of consumers who accept the offer.

12. The method of claim 11, wherein providing the offer further comprises providing each member of the identified group of consumers the offer to participate in the group purchase in which each member of the group who accepts the offer agrees to purchase the pre-designated product for the locked-in pre-determined maximum purchase price, which decreases in the pre-defined relationship to the increase in the number of members of the identified group of consumers who accept the offer within a pre-defined period of time.

13. The method of claim 12, wherein providing the offer further comprises providing each member of the identified group of consumers the offer to participate in the group purchase in which each member of the group who accepts the offer agrees to purchase the pre-designated product for the locked-in pre-determined maximum purchase price, which decreases in increments in a pre-defined relationship to incremental increases in the number of members of the identified group of consumers who accept the offer within a plurality of pre-defined periods of time.

14. The method of claim 11, further comprising providing an interactive capability enabling consumers to access information about the number of members who have accepted the offer and the decrease in the locked-in pre-determined maximum purchase price according to the pre-defined relationship.

15. The method of claim 11, further comprising providing an alert to consumers with information about the number of members who have accepted the offer and the decrease in the locked-in pre-determined maximum purchase price according to the pre-defined relationship.

16. The method of claim 1, wherein negotiating the purchase further comprises negotiating the purchase by a financial institution directly with a manufacturer of the pre-designated product as a broker between the manufacturer and the members of the group who accept the offer.

17. The method of claim 1, wherein negotiating the purchase further comprises negotiating the purchase by a financial institution directly with a retailer having an overstock of the pre-designated product as a broker between the retailer and the members of the group who accept the offer.

18. The method of claim 1, wherein receiving payment further comprises receiving payment via a transactional account from at least one member of the group who accepts the offer to participate in the group purchase.

19. The method of claim 18, wherein receiving the payment via the transactional account further comprises crediting back to the at least one member a discount from a locked-in pre-determined maximum purchase price based on a number of members of the identified group of consumers who accept the offer.

20. A machine-readable medium on which is encoded program code for utilizing consumer transaction data to target and aggregate consumers for a group purchase, comprising instructions for:
maintaining a database storing transaction data consisting at least in part of data related to product purchase transactions for a plurality of consumers;
analyzing the data related to product purchase transactions to identify members of a group of said plurality of consumers with a purchase history indicative of a preference for purchasing products in at least one pre-defined category of products;
providing each member of the identified group of consumers an offer to participate in a group purchase in which each member of the group who accepts the offer agrees to purchase a pre-designated product within the at least one category of products;
negotiating a purchase of a quantity of the pre-designated product from a vendor at a price based at least in part on an aggregation of purchasing power of the members of the group who accept the offer to participate in the group purchase; and
receiving payment from each member of the group who accepts the offer to participate in the group purchase.

21. A computer-implemented system for utilizing consumer transaction data to target and aggregate consumers for a group purchase, comprising:
a database storing transaction data consisting at least in part of data related to product purchase transactions for a plurality of consumers;
means for analyzing the data related to product purchase transactions to identify members of a group of said plurality of consumers with a purchase history indicative of a preference for purchasing products in at least one pre-defined category of products;
means for providing each member of the identified group of consumers an offer to participate in a group purchase in which each member of the group who accepts the offer agrees to purchase a pre-designated product within the at least one category of products;
means for negotiating a purchase of a quantity of the pre-designated product from a vendor at a price based at least in part on an aggregation of purchasing power of the members of the group who accept the offer to participate in the group purchase; and
means for receiving payment from each member of the group who accepts the offer to participate in the group purchase.
